(19) United States
(12) Patent Application Publication
(10) Pub. No.: US 2002/0089252 A1
(43) Pub. Date: Jul. 11, 2002

(54) Resonant shifting and reduction of modal displacement for improved acoustics

(76) Inventors: Troy M. Herndon, San Jose, CA (US); Tan H. Pham, San Marcos, CA (US); Francois Menoud, Capitola, CA (US)

Correspondence Address: THOMASON, MOSER & PATTERSON, LLP, Suite B, 4149 El Camino Way, Palo Alto, CA, 94306-4036, US

(21) Appl. No.: 09/896,006

(22) Filed: Jun. 28, 2001

Related U.S. Application Data
(60) Provisional application No. 60/247,096, filed on Nov. 9, 2000.

(51) Int. Cl. H02K 1/12

(52) U.S. Cl. 310/254

(57) ABSTRACT

An apparatus for reducing vibration and noise in a disc drive spindle motor comprising a first supporting member abutting a first portion of a stator and a second support member abutting a second portion of the stator.

This application claims benefit of United States Provisional Application No. 60/247,096, entitled FIXED-END STATORS FOR REDUCING ACOUSTIC NOISE, filed Nov. 9, 2000 which is hereby incorporated by reference in its entirety.

### FIELD OF THE INVENTION

The invention relates to the field of stator assemblies of the type used in concert with high-speed spindle elements. More specifically, the invention relates to stator assemblies utilized in a disc drive system.

### BACKGROUND OF THE INVENTION

Disc drive memory systems have been used in computers for many years for storage of digital information. Information is recorded on concentric memory tracks of a magnetic disc medium, the actual information being stored in the form of magnetic transitions within the medium. The discs themselves are rotatably mounted on a spindle. The information is accessed using read/write heads generally located on a pivoting arm that moves radially over the surface of the disc. The read/write heads or transducers must be accurately aligned with the storage tracks on the disc to ensure proper reading and writing of information.

During operation, the discs are rotated at very high speeds within an enclosed housing by using an electric motor generally located inside a hub that supports the discs. One type of motor in common use is known as an in-hub or in-spindle motor. Such in-spindle motors typically have a spindle mounted by using two ball or hydrodynamic bearing systems to a motor shaft disposed in the center of the hub. Generally, such motors include a stator comprising a plurality of “teeth” arranged in a circle. The teeth each support a coil that may be sequentially energized to polarize the stator. A plurality of permanent magnets are disposed on a rotor in alternating polarity adjacent the stator. As the coils disposed on the stators are sequentially energized in alternating polarity, the magnetic attraction and repulsion of each stator to the adjacent magnets on the rotor cause the spindle to rotate, thereby rotating the disc and passing the information storage tracks beneath the head.

FIG. 1 is a sectional view of a prior art hydrodynamic bearing spindle motor 100. The spindle motor 100 includes a stationary shaft 102, a hub 104 and a stator 106. The shaft 102 is fixed and attached to a base 108. The hub 104 is supported by the shaft 102 through a bearing 110 for rotation about the shaft 102. The bearing 110 is, for example, a hydrodynamic bearing.

The hub 104 includes a disc carrier flange 112 that supports a disc pack (not shown) for rotation about the shaft 104. The disc pack is held on the disc carrier flange 112 by a disc clamp (not shown). A plurality of permanent magnets 114 are attached to an inner surface 116 of the hub 104, with the hub 104 and the magnets 114 acting as a rotor for the spindle motor 100.

The stator 106 is generally formed of a stack of stator laminations 118 that form a plurality of stator “teeth” that are each wound with an associated stator winding 120. The stator 106 is generally retained in the base 108 by fasteners, adhesives or other conventional methods. In the embodiment illustrated in FIG. 1, the stator 106 is disposed in a pocket 122 formed in the base 108. The stator 106 is cantilever mounted at its inner circumference 124 to the base 108. The distal end 126 of each “tooth” of the stator 106 is unsupported.

As the coils 120 on the stator 106 are sequentially energized to generate a rotational force, the stator 106 vibrates. The vibration that occurs tends to produce an acoustic noise that is irritating to many users and conveys the appearance of an inferiorly constructed unit.

Therefore, there is a need in the art to minimize the vibrations and noise contribution produced by the stator during motor operation.

### SUMMARY OF THE INVENTION

A disc drive spindle motor having improved acoustic properties is provided. In one embodiment, the disc drive spindle motor includes a base, a shaft, a rotor and a stator. A bearing interconnects the rotor with the shaft and allows the rotor to rotate about the shaft. The stator includes a plurality of “teeth” supported by a stationary support member. Each tooth has a coil wound thereover. At least two annular supports positioned beneath the stator support a first portion and a second portion of the stator. Furthermore, the first portion of the stator is bonded to the support housing. By supporting both of the portions, vibrations in the stator are substantially reduced, thereby reducing acoustic noise generated by the motor. To optimize the reduction of vibration, slots can be formed in the annular supports such that the size and spacing of the slots alter the resonant frequency of the motor vibrations. As such, the invention may be used to tune the vibration frequency of the stator away from the resonant frequencies of other components of the motor.

### BRIEF DESCRIPTION OF THE DRAWINGS

The teachings of the invention can be readily understood by considering the following detailed description in conjunction with the accompanying drawings, in which:

FIG. 1 is a sectional view of a prior art spindle motor;

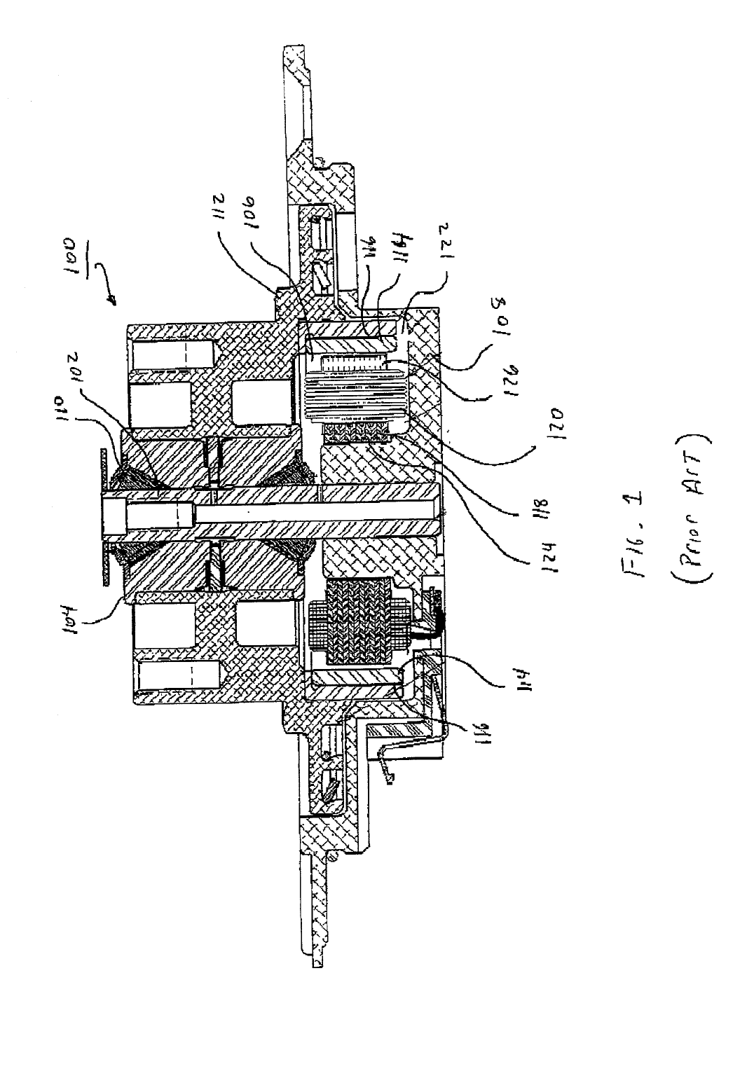

FIG. 2 is a sectional view of a hydrodynamic bearing spindle motor in accordance with the present invention;

FIG. 3 is a horizontal cross-section of one embodiment of a stator in accordance with the invention;

FIG. 4 is a detailed sectional view of the stator shown in FIG. 3, taken along lines 4-4; and

FIGS. 5A, 5B, 5C and 5D are series of plan sections of the housing with the stator removed.

### DETAILED DESCRIPTION OF THE PREFERRED EMBODIMENTS

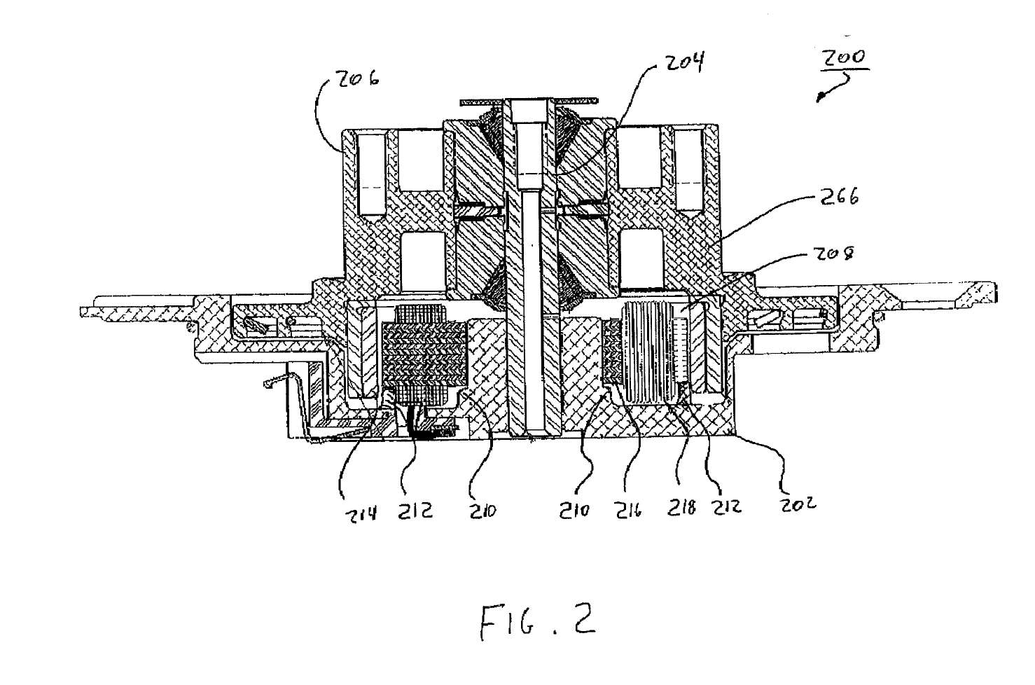

The invention comprises a spindle motor for a disc drive data storage device wherein the stator assembly is supported within the base of the device to reduce acoustic noise. FIG. 2 is a sectional view of a hydrodynamic bearing spindle motor 200 in accordance with the present invention. The spindle motor 200 comprises a motor support base 202, a stationary shaft 204, a hub 206 and a stator 208. Formed within the motor support base 202 are a pair of annular supports 210 and 212 for supporting the stator 208. The annular supports 210 and 212 form concentric circles equidistant from the centrally located shaft 204. These annular supports are formed to support the stator 204 about the stator's first and second external diameters. Other elements and components of the motor such as the permanent magnets 214, the stator laminations 216 and the associated stator windings 218 are common to other motors of this type.

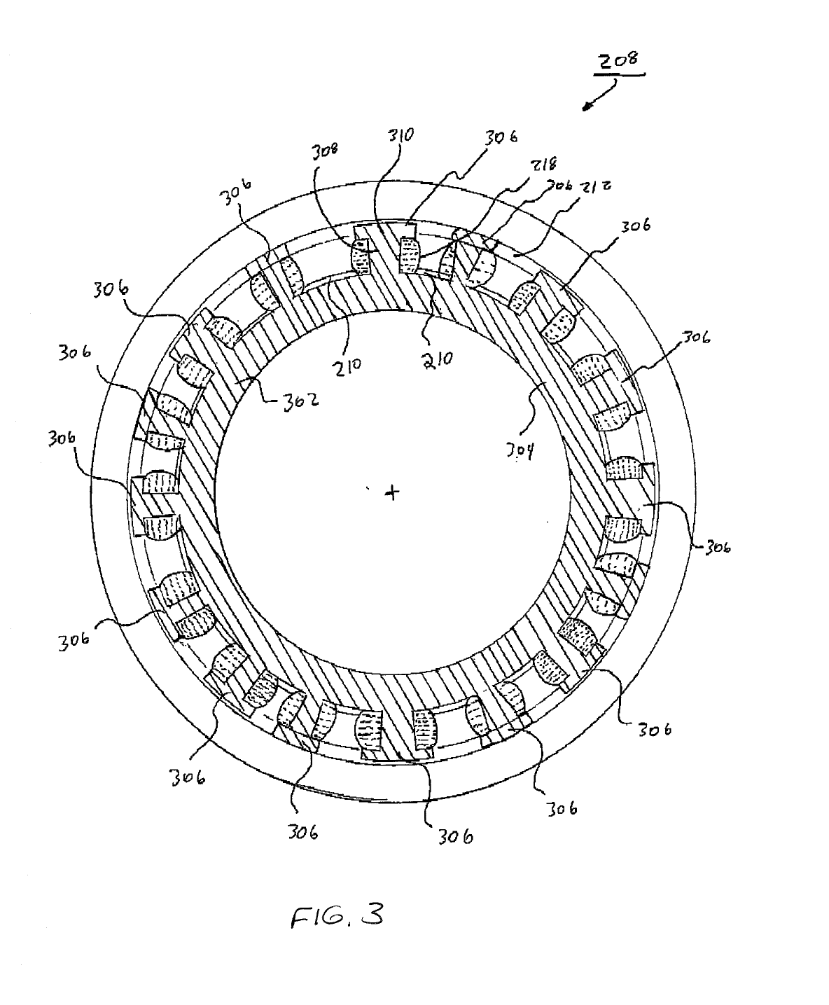

FIG. 3 is a horizontal cross-section of one embodiment of the stator 208 as supported by supports 210 and 212. The stator is supported by at least two annular supports 210 and 212 and bonded to at least one of the supports 210 and 212. The stator 208 comprises a lamination of a plurality of metal plates 302 (a top view of one plate 302 is shown). Each plate 302 is die cut to have an annular portion 304 with a plurality of “T-shaped” teeth 306A-306P extending radially from the annular portion 304. Each tooth 306A-306P comprises a radially extending portion 308 and an end portion 310. For simplicity only, tooth 306A contains reference numbers for portions 308 and 310. Each of the teeth 306A-306P have a winding 218 wrapped about the radially extending portion 308. The inventive stator supports 210 and 212 respectively support the annular portion 304 and the end portion 310 of the stator 208, i.e., the stator 208 is supported on either side of each winding 312. The phase windings 312 can have a number of winding configurations. Some examples of phase windings that may benefit from the invention are discussed in U.S. patent Ser. No. 08/469,643, entitled IRONLESS HYDRODYNAMIC SPINDLE MOTOR, filed Jun. 6, 1995 by Dunfield et al., and in U.S. patent Ser. No. 08/400,661, entitled HYDRODYNAMIC SPINDLE MOTOR HAVING DISTRIBUTED WINDINGS, filed Mar. 8,1995 by Dunfield et al., both of which are commonly assigned and are hereby incorporated by reference in their entireties.

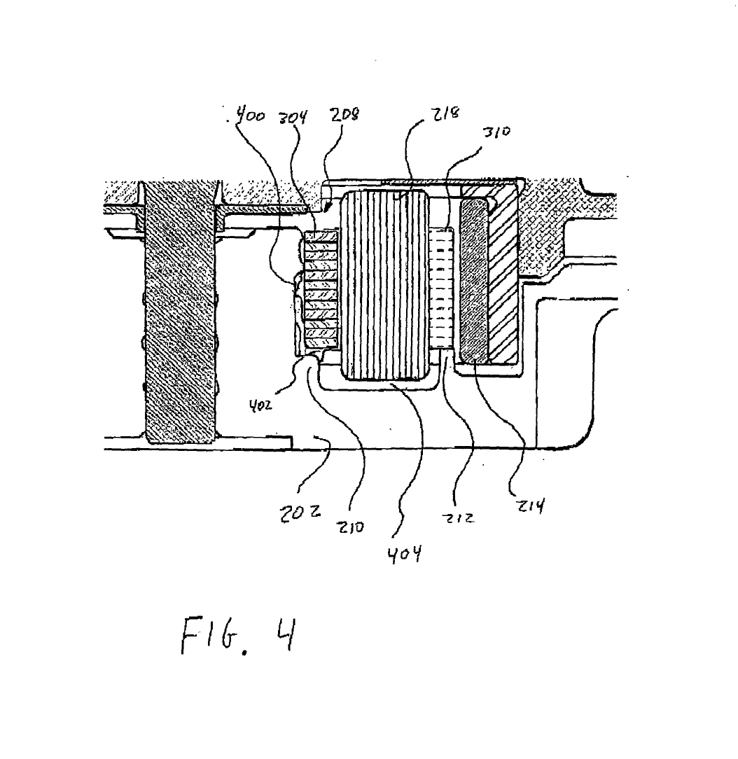

FIG. 4 is a detailed sectional view of the stator 208 of FIG. 2. This figure depicts in detail a section of the stator 208 and the base 202 comprising the first diameter support 210 (e.g., an inner support), the second diameter support 212 (e.g., an outer support) and a section of the first diameter support housing 400 bonded to the stator 208. The second diameter support 212 may also be bonded (e.g., using epoxy) to the stator 208. The stator windings 218 shown are suspended in a trough 404 without contacting the motor support base 202. In this embodiment of the invention, the motor support base 202 is bonded to the annular portion 304 of the stator 208 using an epoxy 402. The support given by both the first diameter support 210 and second diameter support 212 prevents the stator 208 from vibrating. Both the first diameter and second diameter supports 210 and 212 may be segmented or solid in nature. In either case, the supports 210 and 212 follow the annular shape of the stator 208 and as such, form concentric rings equidistant from the central point 304 as shown in FIG. 3.

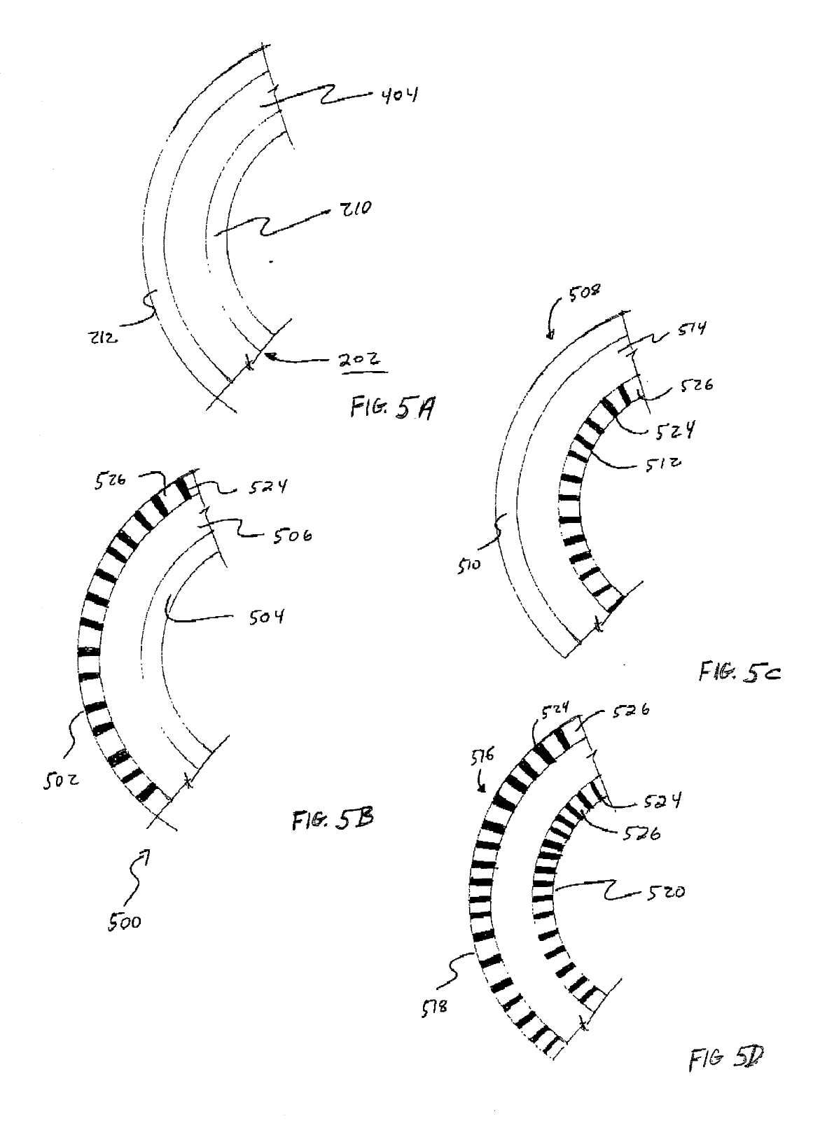

FIG. 5A through 5D depict sections of a plan view showing a portion of the motor base 202. The portion of the motor base 202 depicted is a portion wherein the stator 208 sits and is supported by a first diameter annular support 210 and a second diameter annular support 212 support ring having a trough 404 for the stator's windings formed therebetween. FIGS. 5A, 5B, 5C and 5D each show alternative embodiments of the present invention having combinations of both segmented and solid annular supports 410 and 412. Each of the annular supports 410 and 412 themselves may be either formed in the motor support base 202 or added later as separate components.

FIG. 5A depicts a portion of the housing base 202 comprising a pair of solid annular supports 410 and 412.

FIG. 5B depicts a portion of a housing base 500 having a slotted second annular support 502 and a solid first annular support 504, where the second and first supports 502 and 504 are separated by a trough 506.

FIG. 5C depicts a portion of a housing base 508 comprising a solid second annular support 510 and a slotted first annular support 512 where the second and first supports 510 and 512 are separated by a trough 512.

FIG. 5D depicts a portion of a housing base 516 comprising a slotted second annular support 518 and a slotted first support 520 where the second and first supports 518 and 520 are separated by a trough 522.

The slotted supports 502, 512, 518 and 520 may be formed as a casting or machined into the motor support base. The choice of which specific combination to be used is dependent upon the type of motor being chosen for the particular application. Each type of motor may have a separate set of components which may be unique to the motor's application. This difference in motors may create a variance in the resonance frequency of the motor's component elements. As such, the motor housing's support may resonate at a different frequency, depending on the motor component's resonance frequency. By knowing the excitation frequencies of the motor and other drive components, the choice of motor support housing may be determined. The underlying theory behind the selection of the type of motor support housing, whether it be solid or slotted stator supports, is directly dependent upon the excitation frequencies of the other motor or drive components associated with the motor. By choosing a motor support base design whose known resonant frequency is far different from that of the excitation frequencies of the other motor elements, the potential for creating resonating noise and vibration is significantly reduced.

The relative size and shape of the slots 524 and support portion 526 of each slotted support 502, 512, 518 and 520 can be optimized to alter the resonant frequency of the motor.

The motor shown in the illustrated embodiment is an “outer rotor” type motor where the rotor rotates about the stator. Those skilled in the art will understand that the invention also applied to “inner rotor” type motors where the rotor is located within the stator. With either motor-type, the invention supports the stator in at least two locations to reduce the vibration of the motor.

Although the invention has been described with reference to preferred embodiments, workers skilled in the art will recognize that changes may be made in form and detail without departing from the spirit and scope of the invention. For example, the placement of one or more segmented or solid annular ring members as supports under the stator or in a supporting configuration of the stator can be configured in a variety of ways and can include a combination of the embodiments discussed above. The embodiments shown in the figures are provided by way of example only.

What is claimed is:

1. Apparatus for supporting a stator of an electric motor having a plurality of teeth, where each of the teeth is wound with a stator winding, comprising:
a first support member abutting a first portion of the stator;
a second support member abutting a second portion of the stator.

2. The apparatus of claim 1, wherein said first support member is slotted.

3. The apparatus of claim 1, wherein said second support member is slotted.

4. The apparatus of claim 1, wherein both support members are slotted.

5. The apparatus of claim 1, wherein the first support member is bonded to the stator.

6. The apparatus of claim 1, wherein the second support member is bonded to the stator.

7. The apparatus of claim 1, wherein the first and second support members are annular.

8. The apparatus of claim 1, wherein the first support member supports an inner portion of the stator and the second support member supports an outer portion of the stator.

9. The apparatus of claim 8, wherein the outer portion of the stator is an end portion of the plurality of teeth.

10. The apparatus of claim 1, wherein the first and second support members are solid, continuous support rings.

11. A disc drive data storage system having a motor for rotating a plurality of data storage disks comprising:
a housing having a base and a central axis;
a shaft attached to said base and coaxial with the central axis;
a rotatable member which is rotatable with respect to the shaft; and
a stator, coaxial with the rotatable member, being supported by at least two support members.

12. Apparatus for supporting a stator of an electric motor having a plurality of teeth, where each of the teeth is wound with a stator winding, comprising:
a first support means for supporting a first portion of the stator; and
a second support means for supporting a second portion of the stator.

13. The apparatus of claim 12, wherein the first support means is an annular support member.

14. The apparatus of claim 12, wherein the second support means is an annular support member.

15. The apparatus of claim 12, wherein the first support means is slotted.

16. The apparatus of claim 12, wherein the second support means is slotted.

17. The apparatus of claim 12, wherein both support means are slotted.

18. The apparatus of claim 12, wherein the first support means is bonded to the stator.

19. The apparatus of claim 12, wherein the second support means is bonded to the stator.

20. The apparatus of claim 12, wherein the first support means supports an inner portion of the stator and second support means supports an outer portion of the stator.
